(19) United States
(12) Patent Application Publication
(10) Pub. No.: US 2025/0201805 A1
(43) Pub. Date: Jun. 19, 2025

(54) ANODE AND AN ALL-SOLID-STATE BATTERY INCLUDING SAME

(71) Applicants: HYUNDAI MOTOR COMPANY, Seoul (KR); KIA CORPORATION, Seoul (KR)

(72) Inventors: Kyu Joon Lee, Seoul (KR); Yun Sung Kim, Seoul (KR); Yoon Kwang Lee, Suwon-si (KR); So Young Lee, Suwon-si (KR); Hong Seok Min, Yongin-si (KR); Ga Hyeon Im, Hwaseong-si (KR)

(73) Assignees: HYUNDAI MOTOR COMPANY, Seoul (KR); KIA CORPORATION, Seoul (KR)

(21) Appl. No.: 18/758,407

(22) Filed: Jun. 28, 2024

(30) Foreign Application Priority Data
Dec. 13, 2023 (KR) 10-2023-0181068

(51) Int. Cl. H01M 4/133; H01M 4/02; H01M 4/134; H01M 4/36; H01M 4/38; H01M 4/583; H01M 4/62; H01M 10/052; H01M 10/0562; H01M 10/0585

(52) U.S. Cl. CPC H01M 4/133; H01M 4/134; H01M 4/366; H01M 4/386; H01M 4/583; H01M 4/62; H01M 10/052; H01M 10/0562; H01M 10/0585; H01M 2004/021; H01M 2004/027; H01M 2300/008

(57) ABSTRACT

Proposed is an anode containing an anode active material having a form in which at least a portion of the surface of a carbon material is coated with a lithiophilic material. The fastening pressure or N/P ratio in an all-solid-state battery, including the anode, is adjusted to suppress lithium dendrite growth and increase the energy density of the battery.

### CROSS REFERENCE TO RELATED APPLICATION

The present application claims priority to Korean Patent Application No. 10-2023-0181068, filed Dec. 13, 2023, the entire contents of which are incorporated herein by reference.

### BACKGROUND

### 1. Field of the Disclosure

The present disclosure relates to an anode containing an anode active material and an all-solid-state battery including the anode.

### 2. Description of the Related Art

Recently, to solve environmental problems caused by carbon dioxide (CO₂), the use of fossil fuels has been avoided. Accordingly, in industries where an automobile is used as a mode of transport, interest in electric vehicles (EVs) based on secondary batteries is growing. Although currently available lithium-ion batteries can travel about 400 km on a single charge, problems such as instability at high temperatures and fire remain unsolved. To solve these problems, many companies are competitively developing next-generation secondary batteries.

All-solid-state batteries, which are attracting attention as next-generation secondary batteries, are made of solid components and have the advantages of a lower risk of fire and explosion and higher mechanical strength than those of lithium-ion batteries based on flammable organic solvents as electrolytes. Typically, an all-solid-state battery includes a cathode active material layer bonded to a cathode current collector, an anode active material layer bonded to an anode current collector, and a solid electrolyte layer positioned between the positive and anode active material layers.

While a variety of anode active materials are applicable to all-solid-state batteries compared to lithium-ion batteries, research has been recently conducted actively on applying materials having a high energy density, such as silicon (up to 3600 mAh/g) or lithium (up to 3860 mAh/g), instead of existing graphite (up to 375 mAh/g).

However, silicon exhibits a change in volume of nearly 400% during the charging and discharging process and causes rapid capacity fade due to the loss of contacting surface between silicon and the solid electrolyte, making it challenging to use silicon-based active materials alone. Additionally, lithium dendrites formed during the charging process cause internal short circuits while penetrating a solid electrolyte layer and thus are considered a problem that must be solved.

The statements in this BACKGROUND section merely provide background information related to the present disclosure and may not constitute prior art.

### SUMMARY

The present disclosure, which has been made to solve the problems described above, aims to increase the energy density of an all-solid-state battery by precipitating lithium on the surface and the pores of an anode active material during a charging process.

Additionally, the present disclosure aims to improve battery cycle characteristics and prevent the formation of interfacial cracks caused due to repeated cycles of charging and discharging by keeping the volume of the anode small and suppressing the volume expansion rate of the anode when charging an all-solid-state battery including the same.

Furthermore, the present disclosure aims to solve the problem of an existing all-solid-state battery being operable within a limited voltage range to prevent lithium from being precipitated between a solid electrolyte layer and an anode active material layer and to provide an all-solid-state battery to which a wide voltage range is applicable.

Objectives of the present disclosure are not limited to the objectives mentioned above. The above and other objectives of the present disclosure become more apparent from the following description, and are realized by the means of the appended claims, and combinations thereof.

According to one aspect of the present disclosure, an anode includes: an anode current collector; and an anode active material layer positioned on the anode current collector. The anode active material layer contains an anode active material, in which the anode active material layer has a plurality of pores, and the anode active material contains a carbon material and a lithiophilic material. The lithiophilic material coats at least a portion of the surface of the carbon material.

In the embodiment, the anode active material layer may have a porosity in a range of 0.1% to 20%.

In the embodiment, the lithiophilic material may include at least one of silver (Ag), magnesium (Mg), aluminum (Al), gallium (Ga), zinc (Zn), bismuth (Bi), tin (Sn), indium (In), antimony (Sb), lead (Pb), silicon (Si), germanium (Ge), or any combination thereof.

In the embodiment, the anode active material may have a mean particle diameter (D₅₀) in a range of 0.5 μm to 30 μm.

In the embodiment, the anode active material layer may contain an inorganic electrolyte, such that a weight ratio of the anode active material to the inorganic electrolyte is in a range in a range of 8:2 to 5:5.

According to another aspect of the present disclosure, an all-solid-state battery includes: an anode; a solid electrolyte layer positioned on the anode, the solid electrolyte containing a solid electrolyte; and a cathode positioned on the solid electrolyte layer.

In the embodiment, the all-solid-state battery may further include restraint units positioned outside a stack of the anode, the solid electrolyte layer, and the cathode to compress the stack inward in a direction in which the anode, the solid electrolyte layer, and the cathode are stacked. The restraint units may apply a fastening pressure in a range of 1 MPa to 30 MPa to the stack of the anode, the solid electrolyte layer, and the cathode.

In the embodiment, a ratio of an areal capacity of the anode to an areal capacity of the cathode, i.e., an N/P ratio, may be in a range of 0.5 to 1.2. The N/P ratio of the areal capacity of the anode to the areal capacity of the cathode may be in a range of 0.5 to 1.0.

In the embodiment, in a charged state of the all-solid-state battery, the anode may further contain lithium metal precipitated on either the surface of the lithiophilic material or the pores of the anode active material layer, or both the surface of the lithiophilic material and the plurality of pores of the anode active material layer.

In the embodiment, in an overcharged state of the all-solid-state battery, lithium ions released from the cathode may be precipitated in a lithium metal form on either the surface of the lithiophilic material or the pores of the anode active material layer, or both the surface of the lithiophilic material and the plurality of pores of the anode active material layer, thereby filling the plurality of pores.

In the embodiment, the all-solid-state battery may satisfy Expression 1.

$${η}_{fully charged state} < {η}_{fully discharged state} \qquad [ Expression 1 ]$$

In Expression 1, the η_{fully charged state} is a porosity of the all-solid-state battery in a fully charged state, and the η_{fully discharged state} is a porosity of the all-solid-state battery in a fully discharged state.

In the embodiment, the all-solid-state battery may satisfy Expression 2.

$${V}_{fully charged state} / {V}_{fully discharged state} \leq 1.35 \qquad [ Expression 2 ]$$

In Expression 2, the V_{fully charged state} is a volume of the anode active material layer in a fully charged state, and the V_{fully discharged state} is a volume of the anode active material layer in a fully discharged state.

According to the present disclosure, with the use of an anode active material containing a carbon material and a lithiophilic material coating at least a portion of the surface of the carbon material, the capacity of an all-solid-state battery containing the anode active material can be increased while improving the cycle characteristics.

Additionally, as the restraint units apply a fastening pressure in a range of 1 MPa to 30 MPa to the stack of the anode, the solid electrolyte layer, and the cathode, lithium metal may be precipitated on either the surface of the lithiophilic material or the pores of the anode active material layer, or both the surface of the lithiophilic material and the pores of the anode active material layer when charging the all-solid-state battery. Accordingly, a change in volume of the all-solid-state battery can be prevented, and the cycle characteristics can be improved.

Furthermore, the N/P ratio of the areal capacity of the anode of the all-solid-state battery to the areal capacity of the cathode can be kept low within a range of 0.5 to 1.2, thereby effectively precipitating lithium on the surface of the lithiophilic material or the pores of the anode active material layer. With the application of low fastening pressure to the all-solid-state battery while adjusting the N/P ratio to fall within predetermined range, the lithium metal can be precipitated on the pores by intentionally overcharging the all-solid-state battery.

Effects of the present disclosure are not limited to the effects mentioned above. It should be understood that the effects of the present disclosure include all the effects which can be deduced from the following description.

### BRIEF DESCRIPTION OF THE DRAWINGS

FIG. 1 illustrates an anode according to an embodiment of the present disclosure;

FIG. 2A illustrates a discharged state of an anode according to an embodiment of the present disclosure;

FIG. 2B illustrates a state during a charging and discharging process of an anode according to an embodiment of the present disclosure;

FI. 2C illustrates an overcharged state of an anode according to an embodiment of the present disclosure;

FIG. 3A illustrates an all-solid-state battery according to an embodiment of the present disclosure;

FIG. 3B illustrates restraint units, according to an embodiment of the present disclosure, applying fastening pressure to a stack of an anode, a solid electrolyte layer, and a cathode;

FIGS. 4A and 4B are scanning electron microscope (SEM) images showing Example 1 in a discharged state and a charged state, respectively;

FIGS. 5A and 5B are SEM images showing Comparative Example 1 in a discharged state and a charged state, respectively;

FIGS. 6A and 6B are SEM images showing Example 1 in a charged state at different magnifications;

FIGS. 7A and 7B are SEM images showing Comparative Example 1 in a charged state at different magnifications;

FIGS. 8A and 8B are SEM images showing Comparative Example 2 in a charged state at different magnifications;

FIG. 9 shows voltage curves of all-solid-state batteries according to Example 1 and Comparative Example 1; and

FIG. 10 shows cycle characteristics of all-solid-state batteries according to Example 1 and Comparative Example 1.

The drawings described herein are for illustration purposes only and are not intended to limit the scope of the present disclosure in any way.

### DETAILED DESCRIPTION

The above objectives, and other objectives, features, and advantages of the present disclosure are readily understood from the following embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those having ordinary skill in the art.

Throughout the drawings, like elements are denoted by like reference numerals. In the accompanying drawings, the dimensions of the structures are larger than actual sizes for clarity of the present disclosure. Terms used herein, “first”, “second”, and the like, may be used to describe various components, but the components are not to be construed as being limited to the terms. These terms are used only for the purpose of distinguishing a component from another component. For example, without departing from the scope of the present disclosure, a first component may be referred to as a second component, and a second component may be also referred to as a first component.

As used herein, the singular forms “a”, “an”, and “the” are intended to include the plural forms as well unless the context clearly indicates otherwise. It is further understood that the terms “comprises”, “includes”, or “has” when used herein specify the presence of stated features, regions, integers, steps, operations, elements, and/or components, but do not preclude the presence or addition of one or more other features, regions, integers, steps, operations, elements, components, and/or combinations thereof. It is also understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In this specification, when a range is described for a variable, the variable is understood to include all values within the stated range, including the stated endpoints of the range. For example, a range of “5 to 10” includes values of 5, 6, 7, 8, 9, and 10, as well as any subranges such as 6 to 10, 7 to 10, 6 to 9, and 7 to 9. It is understood to include any value between reasonable integers within the scope of the stated range, such as 5.5, 6.5, 7.5, 5.5 to 8.5, and 6.5 to 9. Additionally, for example, a range of “10% to 30%” includes values, such as 10%, 11%, 12%, and 13%, and all integers up to and including 30%, as well as any subranges such as 10% to 15%, 12% to 18%, and 20% to 30%. It is understood to include any value between reasonable integers within the scope of the stated range, such as 10.5%, 15.5%, and 25.5%.

### Anode

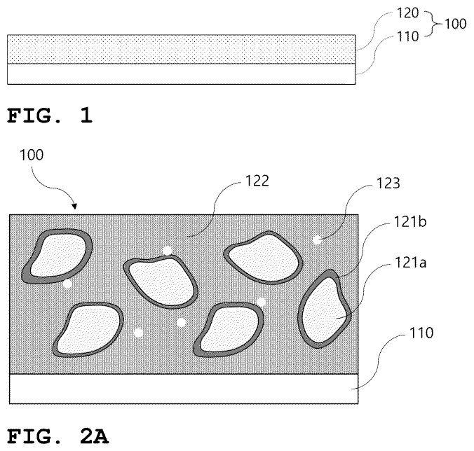

FIG. 1 illustrates an anode 100 according to an embodiment of the present disclosure. The anode 100 includes: an anode current collector 110; and an anode active material layer 120 positioned on the anode current collector 110, the anode active material layer 120 containing an anode active material 121.

The anode current collector 110, configured to transmit current to the anode active material 121 or receive current from the anode active material 121 during charging and discharging, may be an electrically conductive substrate having a plate-like form. Specifically, the anode current collector 110 may have a form of a sheet, thin film, or foil.

The anode current collector 110 may contain a material that does not react with lithium. Specifically, the anode current collector 110 may include at least one selected from the group consisting of nickel (Ni), copper (Cu), stainless steel, and combinations thereof.

The thickness of the anode current collector 110 is not particularly limited but may be, for example, in a range of 1 μm to 500 μm.

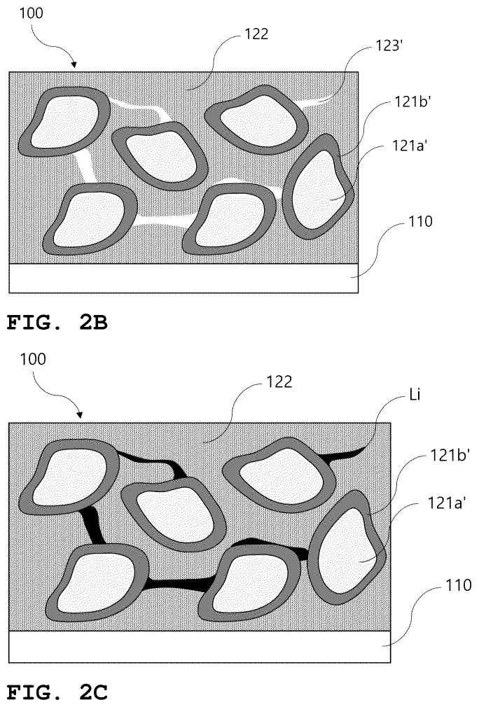

On the other hand, when charging the all-solid-state battery, the anode active material layer 120 may be configured to store lithium ions (Li⁺) that have been released and moved from a cathode active material in the anode active material 121 in the form of lithium compounds. According to the present disclosure, as the lithium ions (Li⁺) are continuously supplied, meaning that the battery is overcharged, even after being sufficiently stored in the anode active material 121, lithium ions may be stored on the surface of the lithiophilic material 121b and pores 123 in the form of lithium metal or lithium precipitates. Hereinafter, the present disclosure is described in detail with reference to FIGS. 2A to 2C. In this case, “overcharged” means that a battery is charged to a capacity beyond the charging capacity of an anode active material layer.

FIG. 2A illustrates a discharged state of the anode 100 according to an embodiment of the present disclosure. According to FIG. 2A, the anode active material layer 120 may have a plurality of pores 123. Additionally, the anode active material 121 contains a carbon material 121a and the lithiophilic material 121b. In this case, at least a portion of the surface of the carbon material 121a may be sufficiently coated or painted with the lithiophilic material 121b, or precipitated to improve lithium-ion conductivity and make the interface between the anode active material 121 and an inorganic electrolyte 122 even.

FIG. 2B illustrates a state during a charging and discharging process of the anode 100 according to the present disclosure. FIG. 2C illustrates a charged state of the anode 100 according to the present disclosure. When charging the all-solid-state battery, lithium ions (Li⁺) moving from the solid electrolyte layer 200, to be described below, may move to the surface of the lithiophilic material 121b and then be stored in the anode active material 121 (121a′ and 121b′) in the form of lithium compounds. During this process, the volume of the anode active material 121 may expand.

FIG. 2C illustrates a state where the anode active material layer 120 is overcharged during the charging process as charging continues even after the lithium ions (Li⁺) are stored in the anode active material (121a′ and 121b′) in the form of the lithium compounds. When continuously charging the all-solid-state battery after the state illustrated in FIG. 2B, the lithium ions (Li⁺) may be precipitated from the surface of the lithiophilic material 121b′. During this process, the lithium ions (Li⁺) may be stored while minimizing volume expansion by filling the pores 123 and cracks 123′ with the lithium metal or lithium precipitate.

As described above, in the charging process of the all-solid-state battery, the lithium ions (Li⁺) may form a lithium alloy on the surface of the lithiophilic material 121b′ or may be precipitated on the pores 123 and the cracks 123′ in the form of the lithium metal. Accordingly, high energy density may be obtained while preventing a change in volume of the anode active material layer 120 during the charging and discharging process.

In one embodiment, the carbon material 121a may include one selected from the group consisting of a particulate carbon material, a fibrous carbon material, and a combination thereof.

The particulate carbon material may include one selected from the group consisting of carbon black, soft carbon, hard carbon, and combinations thereof.

The fibrous carbon material may include one selected from the group consisting of carbon nanofibers, carbon nanotubes, vapor-grown carbon fibers, and combinations thereof.

Additionally, the carbon material 121a may include one selected from the group consisting of natural graphite, artificial graphite, and a combination thereof.

The lithiophilic material 121b is not particularly limited as long as it is capable of forming an alloy with lithium and may, for example, include one selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), germanium (Ge), and combinations thereof. According to an embodiment, the lithiophilic material 121b includes silicon (Si).

The lithium alloy may attract lithium ions (Li⁺) to increase the lithium-ion (Li⁺) diffusion rate. As at least a portion of the surface of the carbon material 121a is coated with the lithiophilic material 121b, the lithium ions (Li⁺) conducted through the solid electrolyte layer 200 may move more quickly in the anode active material layer 120 than in the case where the lithiophilic material 121b is not applied.

In one example, the anode active material layer 120 may contain the inorganic electrolyte 122, a binder, a conductive additive, and the like. In this case, the inorganic electrolyte 122 may be a solid electrolyte having lithium-ion conductivity.

The inorganic electrolyte 122 may include an oxide-based inorganic electrolyte, a sulfide-based inorganic electrolyte, and the like. According to an embodiment, a sulfide-based inorganic electrolyte having high lithium-ion conductivity is used. The sulfide-based inorganic electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, and the like.

Examples of the oxide-based inorganic electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like.

In one embodiment, when the anode active material layer 120 contains the inorganic electrolyte 122, the anode active material layer 120 contains the anode active material and the inorganic electrolyte 122 at a weight ratio in a range of 8:2 to 5:5. When the anode active material 121 is contained at a weight ratio exceeding 8:2, the content of the inorganic electrolyte 122 may be relatively low, leading to a decrease in lithium-ion conductivity. When the anode active material 121 is contained at a weight ratio of lower than 5:5, the energy density of the all-solid-state battery may decrease.

The binder is configured to physically bind each configuration contained in the anode active material layer 120, and examples thereof may include butadiene rubber, nitrile butadiene rubber (NBR), hydrogenated nitrile butadiene rubber (HNBR), polyvinylidene fluoride (PVDF), polytetrafluoroethylene (PTFE), carboxymethyl cellulose (CMC), and the like.

The conductive additive is configured to provide electrical conductivity to the anode active material layer 120, and examples thereof may include carbon black, conducting graphite, ethylene black, carbon fibers, graphene, and the like.

On the other hand, it is advantageous when the porosity of an anode active material layer is low because pores may lead to an increase in internal resistance. However, according to the present disclosure, the electrochemical properties may be positively affected despite the presence of the plurality of pores in the anode active material layer by allowing the N/P ratio and the fastening pressure of the all-solid-state battery to fall within predetermined numerical ranges.

In this regard, the anode active material layer 120 may have a porosity in a range of 0.1% to 20%. When the porosity of the anode active material layer 120 falls within the above numerical range, the change in volume of the anode active material layer 120 during the charging and discharging process may be minimized.

On the contrary, when the porosity is lower than 0.1%, there may not be enough space for the lithium metal to be precipitated in the anode active material layer 120. Thus, a lithium metal layer may be formed between the solid electrolyte layer 200 and the anode active material layer 120 due to lithium metal precipitation. When the lithium metal layer is formed between the solid electrolyte layer 200 and the anode active material layer 120, lithium dendrites may grow during repeated cycles of charging and discharging.

When the porosity exceeds 20%, the thickness of the anode active material layer 120 may be increased, and the interfacial contact between the anode active material 121 and the inorganic electrolyte 122 may be insufficient, thereby damaging the lithium-ion conduction path. Accordingly, the energy density of the all-solid-state battery may decrease, and the battery performance, such as durability, may be deteriorated.

In one embodiment, the anode active material 121 may have a mean particle diameter (D₅₀) in a range of 0.5 μm to 30 μm. In this case, the mean particle diameter of the anode active material 121 may mean a size including the carbon material 121a and the lithiophilic material 121b coating the surface of the carbon material 121a.

When the mean particle diameter of the anode active material 121 exceeds 30 μm, the anode 100 is difficult to be highly densified, leading to a decrease in energy density. When the mean particle diameter of the anode active material 121 is smaller than 0.5 μm, an increase in specific surface area of the anode active material 121 may cause an increase in initial irreversible capacity. Additionally, the amount of the binder used to bind the anode active material 121 to the anode current collector 110 may be increased, leading to a decrease in current density per unit volume of the anode 100.

### All-Solid-State Battery

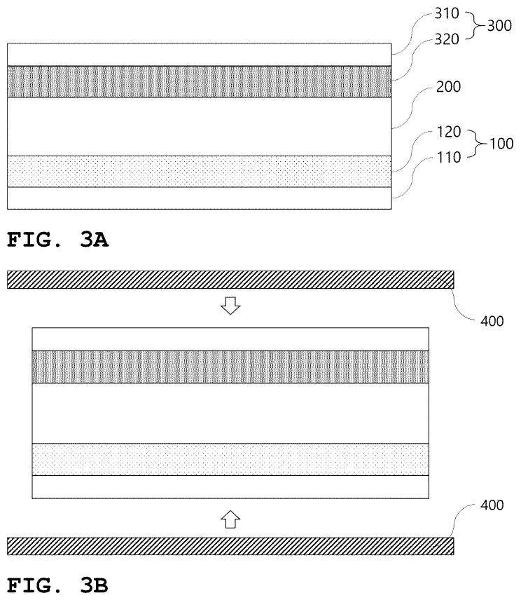

FIG. 3A illustrates an all-solid-state battery according to the present disclosure. Referring to FIG. 3A, the all-solid-state battery, according to the present disclosure, includes: an anode 100; a solid electrolyte layer 200 positioned on the anode 100, the solid electrolyte layer 200 containing a solid electrolyte; a cathode active material layer 320 positioned on the solid electrolyte layer 200, the cathode active material layer 320 containing a cathode active material; and a cathode current collector 310 positioned on the cathode active material layer 320. In this case, an electrode including the cathode active material layer 320 and the cathode current collector 310 may be referred to as a cathode 300.

The anode 100 includes the anode current collector 110 and the anode active material layer 120 described above, so detailed descriptions thereof are omitted.

The solid electrolyte layer 200, positioned between the cathode 300 and the anode 100, may contain a solid electrolyte having lithium-ion conductivity.

The solid electrolyte may include an oxide-based solid electrolyte, a sulfide-based solid electrolyte, and the like. According to an embodiment, the sulfide-based solid electrolyte having high lithium-ion conductivity is used. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, and the like.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), and the like. In this case, the solid electrolyte contained in the solid electrolyte layer 200 may be the same as or different from the inorganic electrolyte 122 contained in the anode active material layer 120.

The cathode active material layer 320 may contain the cathode active material, a solid electrolyte, a conductive additive, a binder, and the like. The cathode active material, configured to store and release lithium ions, may include a rock-salt-layer-type active material, such as LiCoO₂, LiMnO₂, LiNiO₂, LiVO₂, and Li₁₊ₓNi_{1/3}CO_{1/3}Mn_{1/3}O₂, a spinel-type active material, such as LiMn₂O₄ and Li(Ni_{0.5}Mn_{1.5})O₄, an inversed-spinel-type active material, such as LiNiVO₄ and LiCoVO₄, an olivine-type active material, such as L LiFePO₄, LiMnPO₄, LiCoPO₄, and LiNiPO₄, a silicon-containing active material, such as Li₂FeSiO₄ and Li₂MnSiO₄, a rock-salt-layer-type active material in which a part of transition metal is substituted with dissimilar metal, such as LiNi_{0.8}Co_{(0.2-x)} AlₓO₂ (where 0<x<0.2), a spinel-type active material in which a part of transition metal is substituted with dissimilar metal, such as Li₁₊ₓMn_{2-x-y}M_{y}O₄ (where M is at least one among Al, Mg, Co, Fe, Ni, and Zn, and 0<x+y<2), lithium titanate, such as Li₄Ti₅O₁₂, and the like.

Additionally, the surface of the cathode active material may be coated with a lithium metal oxide.

The solid electrolyte, the binder, and the conductive additive contained in the cathode active material layer 320 are practically the same as those described above, so detailed descriptions thereof are omitted.

The cathode current collector 310 may include an electrically conductive substrate having a plate-like form. The cathode current collector 310 may include an aluminum foil. The thickness of the cathode current collector 310 is not particularly limited but may be, for example, in a range of 1 μm to 500 μm.

On the other hand, FIG. 3B illustrates the all-solid-state battery, according to the present disclosure, further including restraint units 400 positioned outside a stack of the anode 100, the solid electrolyte layer 200, and the cathode 300 to compress the stack inward in a direction in which the anode 100, the solid electrolyte layer 200, and the cathode 300 are stacked.

In general, in an all-solid-state battery, all components constituting the battery are solid. Thus, the interfacial bonding condition between the solid electrolyte layer 200 and the cathode active material layer 320, or between the solid electrolyte layer 200 and the anode active material layer 120 may be uneven, compared to the case of using a liquid electrolyte. Accordingly, the interfacial resistance may be high. To solve this problem, in a typical all-solid-state battery, a stack of an anode 100, a solid electrolyte layer 200, and a cathode 300 may be compressed by applying a strong fastening pressure ranging from several tens to several hundreds of MPa.

According to the present disclosure, the restraint units 400 may apply a fastening pressure in a range of 1 MPa to 30 MPa to the stack of the anode 100, the solid electrolyte layer 200, and the cathode 300.

When the all-solid-state battery operates while applying the fastening pressure falling within the above pressure range, the battery may be continuously overcharged after storing lithium ions in the anode active material 121a′ and 121b′ in the form of compounds. Thus, lithium alloys may be formed on the surface of the lithiophilic material 121b′, or lithium metal may be precipitated on the pores 123. In this case, the “pores” may be interpreted to include not only the pores 123 in a discharged state but also the cracks 123′ formed due to the pores 123 widening during the charging process. In other words, the all-solid-state battery, according to the present disclosure, may allow lithium metal to be stored in the anode active material layer 120, including the pores 123 and the surface of the lithiophilic material 121b, in a charged state by intentionally applying low fastening pressure.

When the fastening pressure is lower than 1 MPa, the pores 123 or cracks 123′ of the anode active material layer 120 may excessively widen during the charging process of the all-solid-state battery, leading to an increase in interfacial resistance and internal short circuits of the battery. On the contrary, when the fastening pressure exceeds 30 MPa, the porosity of the anode active material layer 120 may decrease. Additionally, the lithium ions (Li⁺) may be precipitated between the solid electrolyte layer 200 and the anode active material layer 120, rather than in the anode active material layer 120, thus forming a separate lithium metal layer. Accordingly, lithium dendrite growth may be facilitated.

On the other hand, any component commonly used to apply fastening pressure to the all-solid-state battery may be used as the restraint units 400 without particular limitations.

It is known that when designing a secondary battery, the N/P ratio of the areal capacity of the anode 100 to the areal capacity of the cathode 300 may be taken into account.

For example, when the N/P ratio in a typical all-solid-state battery exceeds 1.3, the areal capacity of the anode 100 is much greater than that of the cathode 300, so an SEI layer is excessively formed. Additionally, such an excessively formed SEI layer may act as resistance and decrease the capacity. On the contrary, when the N/P ratio is 1.0 or lower, lithium may not only be unevenly precipitated on the surface of the anode active material but also be precipitated on the interface between the solid electrolyte layer 200 and the anode active material layer 120, thus facilitating lithium dendrite growth.

In one embodiment, the N/P ratio of the areal capacity of the anode 100 to the areal capacity of the cathode 300 may be in a range of 0.5 to 1.2. In one embodiment, the N/P ratio of the areal capacity of the anode 100 to the areal capacity of the cathode 300 is in a range of 0.5 to 1.0. The all-solid-state battery, according to the present disclosure, may suppress the volume of the anode active material layer 120 and the volume expansion rate thereof even when the N/P ratio is set to be in a range of 0.5 to 1.2, which is lower than that in the case of an existing all-solid-state battery.

In particular, in the present disclosure, the N/P ratio of the all-solid-state battery is set to be 1.0 or lower, meaning that the areal capacity of the cathode 300 is adjusted to be greater than or equal to that of the anode 100, to intentionally induce lithium metal precipitation on the pores or cracks. As a result, a smaller thickness or loading amount of the anode active material layer 120 may be exhibited while keeping the same areal capacity of the anode 100, compared to the case where the N/P ratio in an all-solid-state battery exceeds 1.0.

As described above, the all-solid-state battery, according to the present disclosure, may allow lithium metal to be evenly precipitated on the surface or the pores of the anode active material 121 by coating the surface of the anode active material 121 with the lithiophilic material, applying low fastening pressure, and setting the N/P ratio in the battery to be 1.2 or lower, in an embodiment, 1.0 or lower.

When the N/P ratio in the all-solid-state battery is lower than 0.5, the areal capacity of the cathode 300 may become excessively high compared to that of the anode 100, so lithium ions (Li⁺) may be precipitated between the solid electrolyte layer 200 and the anode active material layer 120 in the form of the lithium metal layer without being stored in the anode active material layer 120 in the form of lithium metal layer. In this case, lithium dendrite growth may be facilitated.

In one embodiment, in a charged state of the all-solid-state battery, the anode 100 may further contain lithium metal precipitated on either one or both the surface of the lithiophilic material and the pores 123 or cracks 123′ of the anode active material layer. In this case, the lithium metal may be interpreted as a component capable of forming a lithium alloy with the lithiophilic material. The all-solid-state battery, according to the present disclosure, may allow lithium ions (Li⁺) to be stored in the anode active material layer 120 in the form of the lithium metal or alloy by continuously charging the battery even after the lithium ions (Li⁺) are stored in the anode active material 121a′ and 121b′ in the form of compounds during the charging process and continuously providing lithium ions (Li⁺) to the anode active material layer 120. Accordingly, high energy density may be obtained. Additionally, an excessive amount of lithium metal is unlikely to be precipitated between the solid electrolyte layer 200 and the anode active material layer 120, so lithium dendrite growth may be suppressed.

On the other hand, according to the present disclosure, lithium alloys are formed on the surface of the lithiophilic material 121b′, and the pores 123 are filled with lithium metal precipitated on the pores 123 or cracks 123′ of the anode active material layer 120. Accordingly, the porosity of the anode active material layer 120 may decrease. In this case, a decrease in porosity may be expressed as Expression 1.

$${η}_{fully charged state} < {η}_{fully discharged state} \qquad [ Expression 1 ]$$

In Expression 1, the η_{fully charged state} is a porosity of the all-solid-state battery in a fully charged state, and the η_{fully discharged state} is a porosity of the all-solid-state battery in a fully discharged state.

The charged state may mean a state where lithium ions (Li⁺) released from the cathode move to the anode active material layer 120 through the solid electrolyte layer 200 and encounter electrons to be reduced. The fully charged state may mean a state where a state of charge (SOC) level is 100.

The discharged state may mean a state where lithium ions (Li⁺) released from the anode 100 move to the cathode 300 through the solid electrolyte layer 200 and encounter electrons to be reduced. The fully discharged state may mean a state where an SOC level is 0.

Additionally, when manufacturing the anode 100 having the same areal capacity, a decrease in volume of the anode active material layer 120 may lead to an increase in energy density per volume, which may also lead to a decrease in volume expansion rate. For example, when charging the all-solid-state battery according to the present disclosure, the volume expansion rate of the anode active material layer 120 may be 35% or lower. The lower the volume expansion rate, the better. Additionally, the lower limit is not particularly limited but may be, for example, 0% or higher. In this case, the volume expansion rate may be expressed as Expression 2.

$${V}_{fully charged state} / {V}_{fully discharged state} \leq 1.35 \qquad [ Expression 2 ]$$

In Expression 2, the V_{fully charged state} is a volume of the anode active material layer 120 in a fully charged state, and the V_{fully discharged state} is a volume of the anode active material layer 120 in a fully discharged state.

On the other hand, the maximum voltage level (Vₘₐₓ) Of a typical lithium-ion battery is specified as 4.2 V/cell when fully charged, and the minimum voltage level (Vₘᵢₙ) thereof is specified as 2.7 V/cell when fully discharged. When the lithium-ion battery is charged to the maximum voltage level (Vₘₐₓ) or higher, lithium metal may be precipitated between the anode active material layer 120 and the solid electrolyte layer 200, or the solid electrolyte may be decomposed. Additionally, when discharged to the minimum voltage level (Vₘᵢₙ) or lower, cycle life may be shortened.

The all-solid-state battery, according to the present disclosure, is intended to precipitate lithium metal on the pores 123 or cracks 123′ of the anode active material layer 120 by being overcharged and may be operable in a voltage range of 2.0 to 4.4 V, which is wider than the above voltage range.

Hereinafter, the present disclosure is described in detail with reference to the following examples and comparative examples. However, the spirit of the present disclosure is not limited thereto.

### Example 1—Fastening Pressure: 1 MPa; N/P Ratio: 0.8

(1) Si/Gra active material powder having a form in which the surface of natural graphite (Carbonix Inc; 6 μm to 10 μm) was coated with silicon (Si), a lithiophilic material, using chemical vapor deposition (CVD) was prepared as an anode active material.
(2) The anode active material and Li₆PS₅Cl, an inorganic electrolyte, were weighed at a weight ratio of 6:4 and introduced into a paste-stirring vessel made of high density polyethylene (HDPE). Then, a binder, a nonpolar solvent, and a conductive additive were introduced thereinto and mixed. In this case, an anode slurry was prepared by adding a 5-mm diameter zirconium ball to the stirring vessel for stirring at 2,000 rpm for 5 minutes and resting the resulting product for 3 minutes, which was performed for a total of 30 minutes.
(3) A nickel foil, an anode current collector, was coated with the anode slurry and then dried to obtain an anode having a form in which an anode active material layer was stacked on the anode current collector. In this case, the loading amount of the anode active material layer was set to 4.54 mg/cm².
(4) Next, a battery assembly was manufactured by stacking a solid electrolyte layer, a cathode active material layer, and a cathode current collector on the anode. In this case, the cathode active material layer was loaded such that the N/P ratio of the areal capacity of the anode to the areal capacity of the cathode was set to 0.8.

An aluminum (Al) foil was used as the cathode current collector, and LiNi_{0.8}Co_{0.1}Mn_{0.1}O₂ (NCM811) whose surface was coated with lithium niobate (LiNbO₃) was used as the cathode active material. The solid electrolyte layer was configured to include 97 wt % of Li₆PS₅Cl, a sulfide-based solid electrolyte, 2 wt % of a PVDF binder, and 1 wt % of vapor-grown carbon fibers (VGCF).
(5) The battery assembly was sealed with a pouch, and warm isostatic pressing (WIP) was performed for 30 minutes at a pressure of 450 MPa to provide binding strength between each configuration of the battery assembly.
(6) An all-solid-state battery was manufactured by allowing each restraint unit having a plate-like form to face the upper and lower surfaces of the battery assembly and then applying a fastening pressure of 1 MPa.

### Comparative Example 1—Fastening Pressure: 1 MPa; N/P Ratio: 1.1

An all-solid-state battery was manufactured through the same process as in Example 1, except that in the process of obtaining the anode, the loading amount of the anode active material layer was set to 11.2 mg/cm², and in the process of manufacturing the battery assembly, the cathode active material layer was loaded such that the N/P ratio of the areal capacity of the anode to the areal capacity of the cathode was set to 1.1. In this case, the areal capacity of the anode in Comparative Example 1 was designed to be similar to that of the anode in Example 1.

### Comparative Example 2—Fastening Pressure: 35 MPa; N/P Ratio: 0.8

An all-solid-state battery was manufactured through the same process as in Example 1, except that in the process of manufacturing the all-solid-state battery, a fastening pressure of 35 MPa was applied to the battery assembly. In this case, the areal capacity of the anode in Comparative Example 2 was designed to be similar to that of the anode in Example 1.

### Experimental Example 1—Measurement of Volume Expansion Rate of Anode Active Material Layer

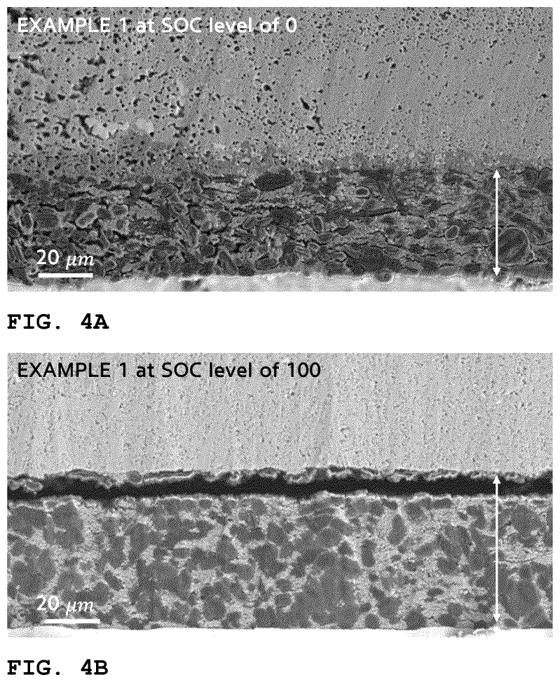

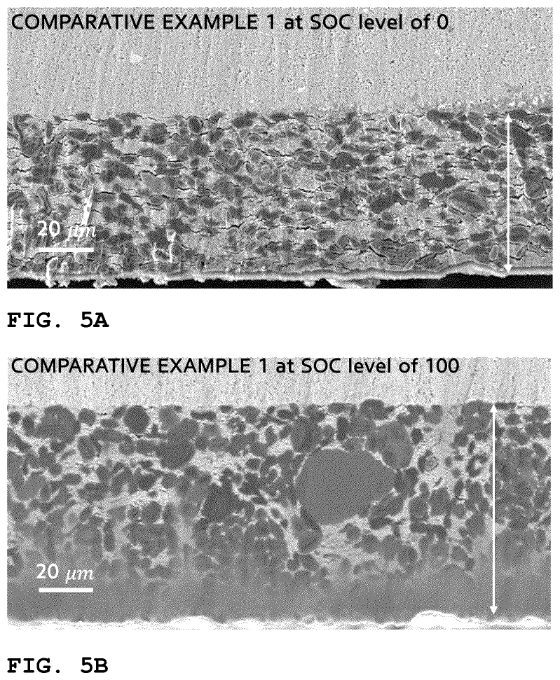

To examine the increasing volume expansion rate of the anode active material layer during a charging process, each of the all-solid-state batteries, according to Example 1 and Comparative Example 1, was charged and discharged once under the following charging and discharging conditions. The cross-sectional image of each anode of the all-solid-state batteries, according to Example 1 and Comparative Examples 1 and 2, was taken with a scanning electron microscope (SEM). The results for Example 1 are shown in FIGS. 4A and 4B, and the results for Comparative Example 1 are shown in FIGS. 5A and 5B. In this case, the all-solid-state battery was charged while keeping the fastening pressure described above in Example 1 or Comparative Example 1.

The all-solid-state battery, according to Example 1, was charged with a constant current of 0.1 C for 15 hours and 30 minutes (lithiation) and then discharged to a voltage level of 1.5 V (delithiation) based on an anode potential level. The all-solid-state battery, according to Comparative Example 1, was charged with a constant current of 0.1 C to a voltage level of 0.01 V based on an anode potential level (lithiation) and then discharged to a voltage level of 1.5 V (delithiation).

According to FIG. 4A, the thickness of the anode active material layer was measured to be about 44 μm in a discharged state. Additionally, according to FIG. 4B, the thickness of the anode active material layer was measured to be about 58 μm in a charged state. This confirmed that the volume of the anode active material layer included in the all-solid-state battery, according to Example 1, increased by about 31.8% during the charging process. In this case, the black layer of FIG. 4B formed between the solid electrolyte layer positioned at the top and the anode active material layer positioned at the bottom is shown as the solid electrolyte layer and the anode active material layer are partially detached during the process of preparing the cross section of the anode, but is not interpreted as a separated layer formed.

According to FIG. 5A, the thickness of the anode active material layer was measured to be about 68 μm in a discharged state. Additionally, according to FIG. 5B, the thickness of the anode active material layer was measured to be about 93 μm in a charged state, confirming that the volume of the anode active material layer, included in the all-solid-state battery according to Comparative Example 1, increased by about 36.7% during the charging process.

Additionally, although not separately shown, in the case of the all-solid-state battery according to Comparative Example 2, the thickness of the anode active material layer was measured to be about 44 μm in a discharged state, and the thickness of the anode active material layer was measured to be about 63 μm in a charged state, confirming that the volume of the anode active material layer, included in the all-solid-state battery according to Comparative Example 2, increased by about 43.2% during the charging process.

All of the all-solid-state batteries, according to Example 1 and Comparative Examples 1 and 2, are similar in areal capacity of the anode. Nevertheless, in the case of Example 1, where the fastening pressure and the N/P ratio were set to be relatively low, allowing lithium ions (Li⁺) to be intentionally precipitated on the pores of the anode active material layer in the process of charging the battery, it was confirmed that the thickness of the anode active material layer was small, and the volume expansion rate thereof was low.

### Experimental Example 2—Structural Analysis of all-Solid-State Battery

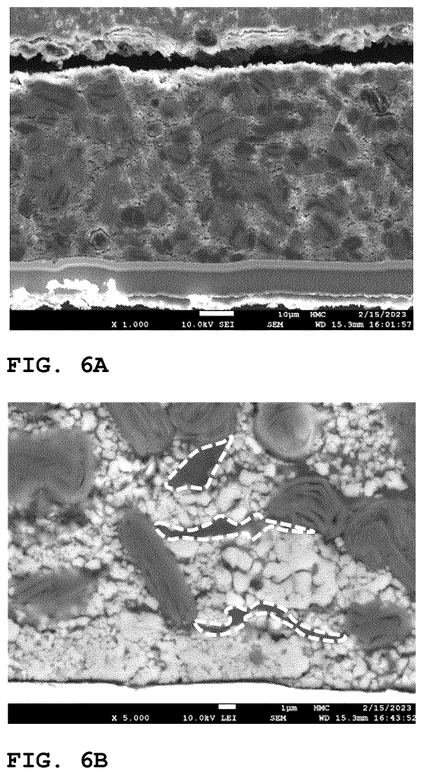

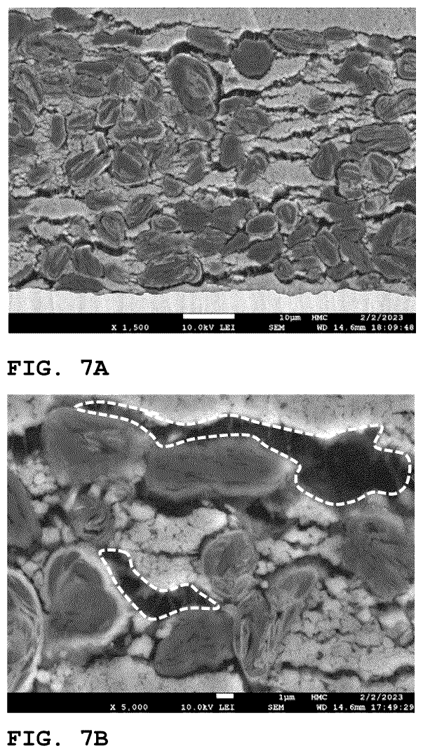

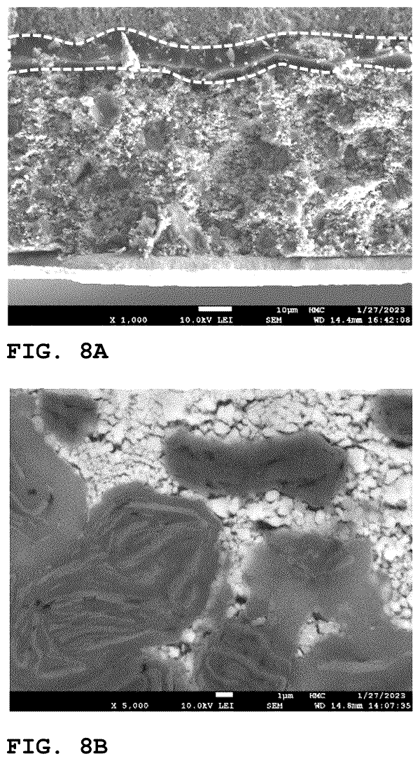

To analyze the structure of the all-solid-state battery in a charged state, each of the all-solid-state batteries, according to Example 1 and Comparative Examples 1 and 2, was charged and discharged once under the charging and discharging conditions according to Experimental Example 1. Then, images thereof were taken with an SEM at different magnifications. Each result for Example 1 is shown in FIGS. 6A and 6B, each result for Comparative Example 1 is shown in FIGS. 7A and 7B, and each result for Comparative Example 2 is shown in FIGS. 8A and 8B.

From FIGS. 6A and 6B, it is confirmed that lithium metal is precipitated on the surface of the anode active material, meaning the surface of the lithiophilic material, and the pores contained in the anode active material layer. In this case, as to be confirmed in Experimental Example 3, it is predicted that lithium metal or lithium precipitates are formed because the constant current charging causes the charging voltage level to drop below 0 V.

From FIGS. 7A and 7B, it was observed that cracks or pores still existed in the anode active material layer. In other words, this may mean that lithium ions (Li⁺) released from the cathode active material during the charging process are stored in the form of ions without being stored in the form of metal in the anode active material layer.

From FIGS. 8A and 8B, a lithium metal layer was observed to be formed due to lithium precipitated between the anode active material layer and the solid electrolyte layer. Additionally, when observing the anode active material layer in an enlarged manner, no separate cracks or pores were observed. In this case, although charging was performed with the constant current, the lower limit of the voltage level was not set in Comparative Example 2, unlike Comparative Example 1. Additionally, it is predicted that a lithium metal layer is formed between the anode active material layer and the solid electrolyte layer because the constant current charging causes the charging voltage level to drop below 0 V.

Through this, in the case of Example 1, where both the fastening pressure and the N/P ratio were kept low, it was confirmed that the thickness of the anode active material layer was kept small while suppressing the volume expansion rate at a minimum level by allowing lithium metal to be precipitated on the surface of the lithiophilic material and the pores contained in the anode active material layer. Additionally, it is predicted that as the pores, serving as a factor increasing the interfacial resistance between the anode active material and the solid electrolyte contained in the anode active material layer, are filled with the lithium metal or lithium precipitates, cycle characteristics may be improved.

On the other hand, in the case of Comparative Example 1, where the fastening pressure was kept low while keeping the N/P ratio relatively high, it was confirmed that the lithium ions, released from the cathode active material, were not stored in the form of lithium metal having high energy density. This may demonstrate that although the areal capacity of the anode is similar, the thickness is larger, and the volume expansion rate is higher in the case of Comparative Example 1 than in the case of Example 1.

Additionally, in Comparative Example 2, where the N/P ratio was set to be the same as that of Example 1 while keeping the fastening pressure relatively high, it was confirmed that a lithium metal layer formed between the anode active material layer and the solid electrolyte layer failed to suppress lithium dendrite growth in the solid electrolyte layer. This is predicted to be because the porosity of the anode active material layer in Comparative Example 2 is reduced, thus creating an environment where lithium metal is more likely to be precipitated on the interface between the solid electrolyte layer and the anode active material layer, rather than in the anode active material layer.

### Experimental Example 3—Analysis of Electrochemical Properties of all-Solid-State Battery

While manufacturing the anodes and the solid electrolyte layers through the processes described in Example 1 and Comparative Examples 1 and 2, half-cells were manufactured using lithium metal foil as a counter-cathode.

To examine the electrochemical properties of the half-cells, the half-cells, according to Example 1 and Comparative Example 1, were charged and discharged under the following conditions. The results thereof are shown in FIG. 9 as a graph of specific capacity against voltage (V).

After charging the half-cell, according to Example 1, with a constant current of 0.1 C for 15 hours and 30 minutes (lithiation), 3 cycles of charging and discharging were performed to be discharged to a voltage level of 1.5 V (delithiation). From the fourth cycle of charging and discharging, a process of being charged with a constant current of 0.33 C for 4 hours and 40 minutes (lithiation) and then discharged to a voltage level of 1.5 V (delithiation) was repeatedly performed.

After charging the half-cell, according to Comparative Example 1, with a constant current of 0.1 C to a voltage level of 0.01 V (lithiation), 3 cycles of charging and discharging were performed to be discharged to a voltage level of 1.5 V (delithiation). From the fourth cycle of charging and discharging, a process of being charged with a constant current of 0.33 C to a voltage level of 0.01 V (lithiation) and then discharged to a voltage level of 1.5 V (delithiation) was repeatedly performed.

After charging the half-cell, according to Comparative Example 2, with a constant current of 0.1 C for 15 hours and 30 minutes (lithiation), 3 cycles of charging and discharging were performed to be discharged to a voltage level of 1.5 V (delithiation). From the fourth cycle of charging and discharging, a process of being charged with a constant current of 0.33 C for 4 hours and 40 minutes (lithiation) and then discharged to a voltage level of 1.5 V (delithiation) was repeatedly performed. In this case, the results for Comparative Example 2 are not shown separately in the drawings but are shown only in Table 1.

According to FIG. 9, it was confirmed that the battery capacity in Example 1 was further improved compared to that in Comparative Example 1.

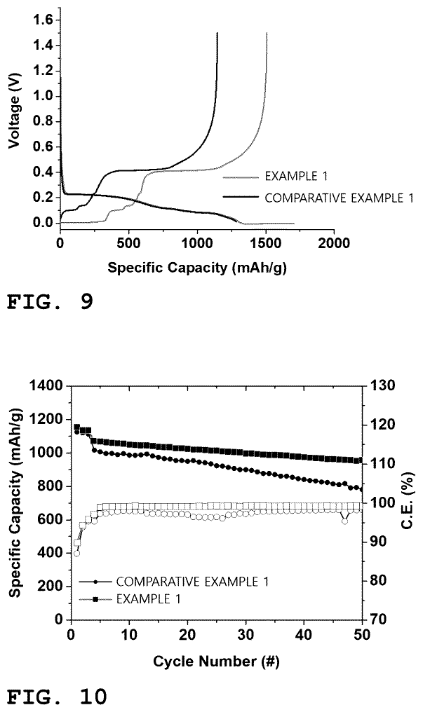

Additionally, to examine the cycle characteristics of the all-solid-state battery, capacity was measured through repeated cycles of charging and discharging performed on the half-cells according to Example 1 and Comparative Example 1. The results thereof are shown in FIG. 10.

According to FIG. 10, it was confirmed that the cycle characteristics in Example 1 were further improved compared to those in Comparative Example 1.

On the other hand, the results, according to Experimental Examples 1 to 3, are summarized and listed in Table 1.

TABLE 1

| | | Loading | Areal | | | | | |
|---|---|---|---|---|---|---|---|---|
| | | amount of | capacity | | | | | Volume |
| | Active | anode | of anode | N/P | Fastening | Voltage | Electrode | expansion |
| | material | (mg/cm²) | (mAh/g) | ratio | pressure | range | thickness | rate |
| Comparative | Si/Gr | 11.2 | 7.17 | 1.1 | 1 MPa | 2.0 to | 68 μm | 36.7% |
| Example 1 | | | | | | 4.3 V | | |
| Comparative | Si/Gr | 4.54 | 7.08 | 0.8 | 35 MPa | 2.0 to | 44 μm | 43.2% |
| Example 2 | | | | | | 4.3 V | | |
| Example 1 | Si/Gr | 4.54 | 7.08 | 0.8 | 1 MPa | 2.0 to | 44 μm | 31.8% |
| | | | | | | 4.3 V | | |

Although embodiments of the present disclosure have been disclosed for illustrative purposes, those having ordinary skill in the art should appreciate that diverse variations and modifications are possible through addition, alteration, deletion, and the like of elements, without departing from the spirit and scope of the present disclosure.

What is claimed is:

1. An anode comprising:
an anode current collector; and
an anode active material layer positioned on the anode current collector, the anode active material layer comprising an anode active material,
wherein the anode active material layer comprises a plurality of pores, and
the anode active material comprises a carbon material and a lithiophilic material, the lithiophilic material coating at least a portion of a surface of the carbon material.

2. The anode of claim 1, wherein the anode active material layer has a porosity in a range of 0.1% to 20%.

3. The anode of claim 1, wherein the lithiophilic material comprises at least one of silver (Ag), magnesium (Mg), aluminum (Al), gallium (Ga), zinc (Zn), bismuth (Bi), tin (Sₙ), indium (In), antimony (Sb), lead (Pb), silicon (Si), germanium (Ge), or any combination thereof.

4. The anode of claim 1, wherein the anode active material has a mean particle diameter (D₅₀) in a range of 0.5 μm to 30 μm.

5. The anode of claim 1, wherein the anode active material layer comprises an inorganic electrolyte, and
the anode active material layer comprises the anode active material and the inorganic electrolyte at a weight ratio in a range of 8:2 to 5:5.

6. An all-solid-state battery comprising:
an anode;
a solid electrolyte layer positioned on the anode, the solid electrolyte layer comprising a solid electrolyte; and
a cathode positioned on the solid electrolyte layer,
wherein the anode comprises:
an anode current collector; and
an anode active material layer positioned on the anode current collector, the anode active material layer comprising an anode active material,
wherein the anode active material layer comprises a plurality of pores, and
the anode active material comprises a carbon material and a lithiophilic material, the lithiophilic material coating at least a portion of a surface of the carbon material.

7. The all-solid-state battery of claim 6, further comprising restraint units positioned outside a stack of the anode, the solid electrolyte layer, and the cathode to compress the stack inward in a direction in which the anode, the solid electrolyte layer, and the cathode are stacked,
wherein the restraint units apply a fastening pressure in a range of 1 MPa to 30 MPa to the stack of the anode, the solid electrolyte layer, and the cathode.

8. The all-solid-state battery of claim 6, wherein a ratio of an areal capacity of the anode to an areal capacity of the cathode (N/P ratio) is in a range of 0.5 to 1.2.

9. The all-solid-state battery of claim 6, wherein a ratio of an areal capacity of the anode to an areal capacity of the cathode (N/P ratio) is in a range of 0.5 to 1.0.

10. The all-solid-state battery of claim 6, wherein in a charged state of the all-solid-state battery, the anode comprises a lithium metal precipitated on at least one of a surface of the lithiophilic material or the plurality of pores of the anode active material layer.

11. The all-solid-state battery of claim 6, wherein in an overcharged state of the all-solid-state battery, lithium ions released from the cathode are precipitated in a lithium metal form on a surface of the lithiophilic material and the plurality of pores of the anode active material layer, thereby filling the plurality of pores.

12. The all-solid-state battery of claim 6, wherein the all-solid-state battery satisfies the following expression:
η_{fully charged state}<η_{fully discharged state},
where the η_{fully charged state} is a porosity of the all-solid-state battery in a fully charged state, and the η_{fully discharged state} is a porosity of the all-solid-state battery in a fully discharged state.

13. The all-solid-state battery of claim 6, wherein the all-solid-state battery satisfies the following expression:
$${V}_{fully charged state} / {V}_{fully discharged state} \leq 1 \text{.35} ,$$
where the V_{fully charged state} is a volume of the anode active material layer in a fully charged state, and the V_{fully discharged state} is a volume of the anode active material layer in a fully discharged state.
